(19) United States
(12) Patent Application Publication
(10) Pub. No.: US 2017/0057115 A1
(43) Pub. Date: Mar. 2, 2017

(54) HAND PLANE WITH SUSPENSION DEPTH CONTROL

(71) Applicant: Maxwell Keeling, Ithaca, NY (US)

(72) Inventor: Maxwell Keeling, Ithaca, NY (US)

(21) Appl. No.: 15/253,287

(22) Filed: Aug. 31, 2016

Related U.S. Application Data
(60) Provisional application No. 62/212,890, filed on Sep. 1, 2015.

(51) Int. Cl. B27G 17/02

(52) U.S. Cl. CPC B27G 17/02

(57) ABSTRACT

A hand tool of the present invention enables the planing of stock wood to thickness that is accurate and repeatable without the need for continuous measurement or great skill. The hand tool can be used on stock that is wider than the plane body, can be adjusted in depth by the user, and is of suitable construction and weight for a hand tool.

### RELATED APPLICATION DATA

This application claims priority to U.S. Provisional Application No. 62/212,890 filed Sep. 1, 2016 and titled “Hand Plane with Suspension to Control Depth of Cut,” and is incorporated herein in its entirety.

### FIELD OF THE INVENTION

The present invention generally relates to hand tools. In particular, the present invention is directed to a Hand Plane with Suspension Depth Control.

### BACKGROUND

In the production of solid wood articles such as furniture, stock preparation is usually an essential step. Stock preparation typically consists of working a piece of rough cut or irregular wood into a smooth-sided rectangular prism of consistent thickness and with at least two sets of parallel faces, with each set of faces perpendicular to the other. This prepared condition is referred to as “surfaced four sides,” or “S4S” in the terminology of the craft.

Though machine tools, such as jointer and planer machines, have long existed to speed the task of stock preparation, many woodworkers continue to use unpowered hand tools. This is often because power tools require large amounts of shop space, and can be difficult to transport due to their weight. Noise, dust, and safety problems are also reduced by the use of hand tools. Finish quality is often seen as better with hand tools as well. Finally, hand tools are often less expensive for woodworkers.

There are many traditional techniques for preparing stock using hand tools. Traditionally, the flattening of the boards is accomplished using one, or a series, of hand planes. Using these planes, the woodworker will first flatten one side of a board, and then flatten the opposite side of the board, carefully checking and measuring to ensure the second side is planed to produce the desired final thickness, while maintaining the second side parallel with the first.

Unfortunately, for many woodworkers this process can be difficult to perform consistently with traditional hand planes. The process of planing must be monitored carefully to avoid removing too much material, and to remove material evenly across the face of the board. This process requires expertise to perform correctly, and can be very difficult to perform consistently on many different boards.

The process of thicknessing boards, or creating the second parallel face to the first flattened face, is often seen as especially difficult. Creating this parallel face is so difficult that many woodworkers who prefer hand tools, and begin their stock preparation using hand planes to create one flat face, still use a powered planer machine to work the opposite face (and create the final thickness) of the board.

To ease this process of thicknessing stock, fence arrangements have been used on tools to control the depth of cut on hand planes. One design approach has been to attach a skid to opposing sides of a plane body, with the contacting surface of the skids each independently being adjustable to sit at some level below the sole of the plane and in contact with a support surface (e.g., worktable). Thus, the plane is used with the skids straddling the board being worked. As material is removed, the plane descends closer to the workbench top on which the board is resting. When the skids touch the workbench surface, the plane can descend no further and cutting ceases. This prevents cutting past a set thickness, as determined by the depth adjustment of the skids, and makes thicknessing small boards much easier and faster (assuming that the user has a flat worktable).

Examples of the above described fence arrangement, which will be referred to as “independent skid designs” in the remainder of this document, share the following characteristics:
The skids reference the surface the workpiece is placed upon, not the workpiece itself;
The two skids are separate bodies that are independently adjusted, and;
The skids extend directly down from the sides of the plane body.

These independent skid designs share several notable limitations, among others. For example, when the skids extend directly downward from the sides of the plane, the plane is unable to utilize the skids when planing stock wider than the blade of the plane, since the skids must straddle the stock. Moreover, the user must independently adjust each skid on the plane when setting the final planing thickness to be made, which adds time to the adjustment process and also requires the user to match the adjustment on both skids to produce flat results. Additionally, by requiring separate extending fences on either side with attached vertical skids, the weight of the overall assembly is increased and the stiffness will be decreased, which are disadvantages for a hand-held tool, especially one that is unpowered like a hand plane and where the user is applying pressure to the “center” of the device, thus possibly causing downward deflections and removing too much material.

### SUMMARY OF THE DISCLOSURE

In an exemplary aspect, a hand tool for creating a parallel surface opposite the flat side of a workpiece is disclosed, the hand tool comprising: a plane assembly including a frame and a blade, wherein the frame has a bed and the blade extends below the bed; a suspension assembly coupled to the plane assembly, wherein the suspension assembly is adjustable relative to the bed of the plane assembly; and at least one horizontal extension coupled to the suspension assembly such that the horizontal extension is disposed above the bed of the plane assembly, and wherein the horizontal extension extends substantially orthogonal from the longitudinal axis of the suspension assembly and has a length greater than the width of the workpiece.

In another exemplary aspect, a hand tool kit for creating a parallel surface opposite the flat side of a workpiece is disclosed, the hand tool kit comprising: a plane assembly including a frame and a blade, wherein the frame has a bed and the blade extends below the bed; a suspension assembly coupled to the plane assembly, wherein the suspension assembly is adjustable relative to the bed of the plane assembly; at least one horizontal extension coupled to the suspension assembly such that the horizontal extension is disposed above the bed of the plane assembly, and wherein the horizontal extension extends substantially orthogonal from the longitudinal axis of the suspension assembly and has a length greater than the width of the workpiece; and a plurality of guide tracks having substantially similar widths.

### BRIEF DESCRIPTION OF THE DRAWINGS

For the purpose of illustrating the invention, the drawings show aspects of one or more embodiments of the invention. However, it should be understood that the present invention is not limited to the precise arrangements and instrumentalities shown in the drawings, wherein:

FIG. 1 shows a perspective view of the hand tool in an exemplary environment according to an embodiment of the present invention;

FIG. 2 shows a cross section view of the hand tool of FIG. 1;

FIG. 3 shows a partially exploded perspective view of the hand tool of FIG. 1;

FIG. 4 shows an exploded view of the hand tool of FIG. 1;

FIGS. 5A and 5B are cross section plan views of the hand tool of FIG. 1, showing an exemplary range of motion of the plane assembly relative to the suspension assembly, at minimum (FIG. 5A) and maximum (FIG. 5B);

FIG. 6 is a perspective view of a hand tool according to another embodiment of the present invention;

FIGS. 7A and 7B are perspective and side views of a hand tool according to another embodiment of the present invention;

FIG. 8 is a perspective view of a hand tool according to another embodiment of the present invention; and

FIG. 9 is a block diagram of an exemplary process for thicknessing a workpiece.

### DESCRIPTION OF THE DISCLOSURE

A hand tool of the present invention enables the planing of stock wood to thickness that is accurate and repeatable without the need for continuous measurement or great skill. The hand tool can be used on stock that is wider than the plane body and can be adjusted in depth by the user, and is of suitable construction and weight for a hand tool.

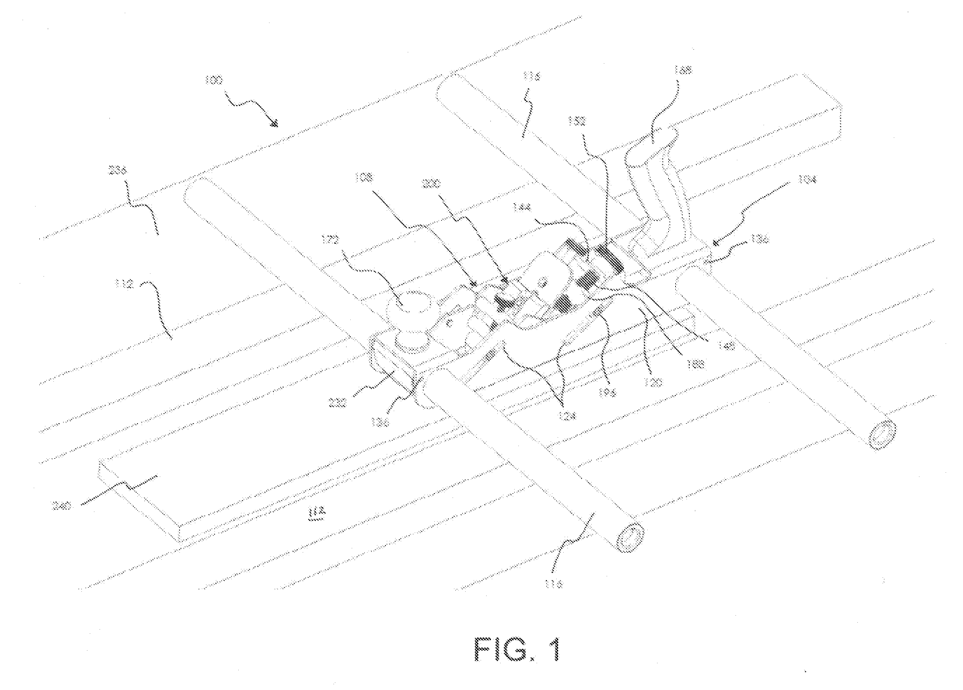

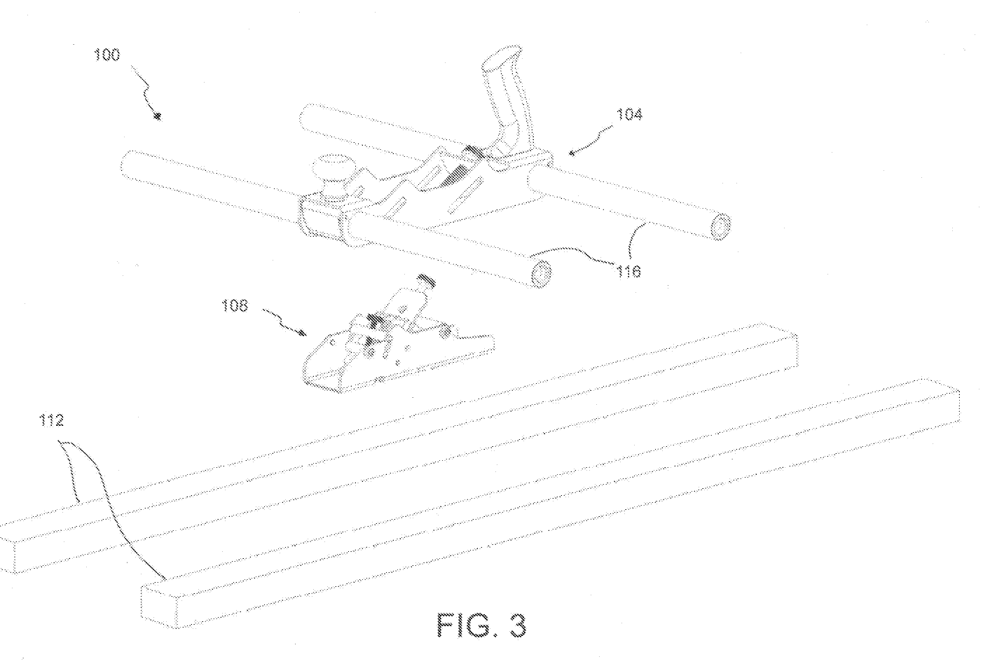

Turning now to the figures, and in particular to FIGS. 1 to 4, there is shown a hand tool 100 that is comprised of three main subassemblies; the suspension assembly 104, the plane assembly 108, horizontal extensions 116 and the guide tracks 112. The plane assembly 108 is contained within the suspension assembly 104.

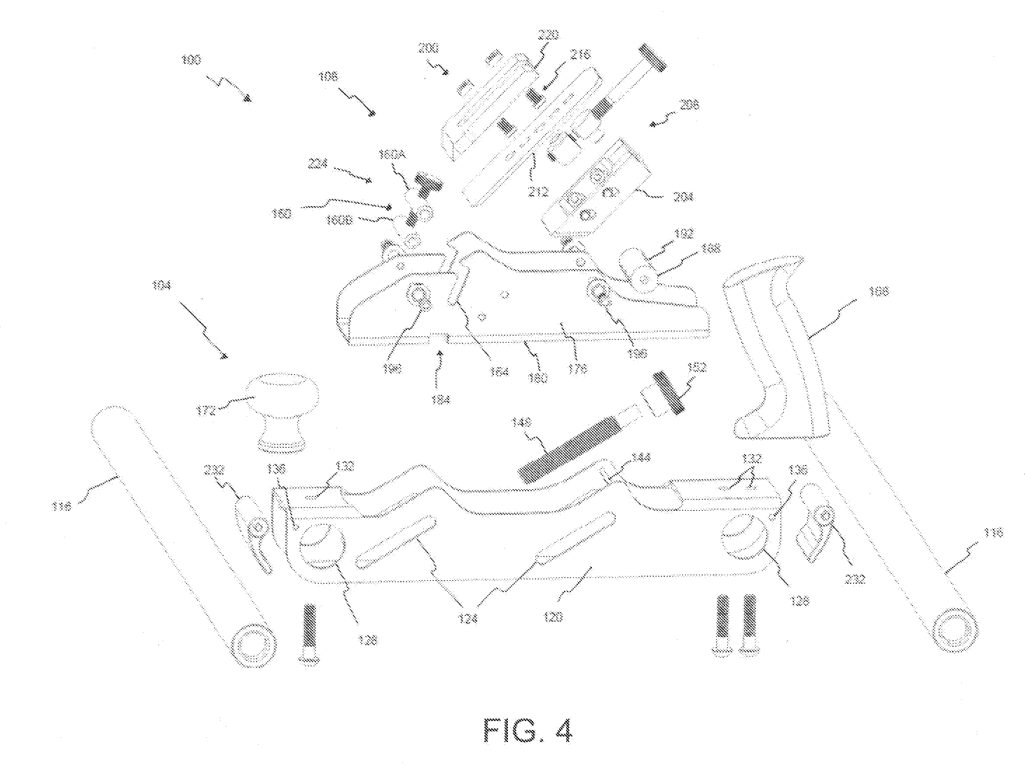

Suspension assembly 104 is configured to surround plane assembly 108, move relative to plane assembly 108, and to support horizontal extensions 116 that use guide tracks 112. In an exemplary embodiment, suspension assembly 104 includes a frame 120, which has a plurality of apertures that are generally mirrored on opposing sides. For example, and as best seen in FIG. 4, suspension assembly frame 120 includes a plurality of depth slots 124, a plurality of extension holes 128, a plurality of handle attachment holes 132, a plurality of extension lock holes 136. As discussed in more detail below, the slots and holes set forth above allow for the mating with the plane assembly 108 and horizontal extensions 116 and the movement of the place assembly relative to the suspension assembly. In an exemplary embodiment, suspension assembly 104 is formed from sheet steel in a U-shaped bend pattern although it is understood that other suitable materials could be used and other manufacturing processes, e.g. machining, casting, could be used to fabricate suspension assembly 104.

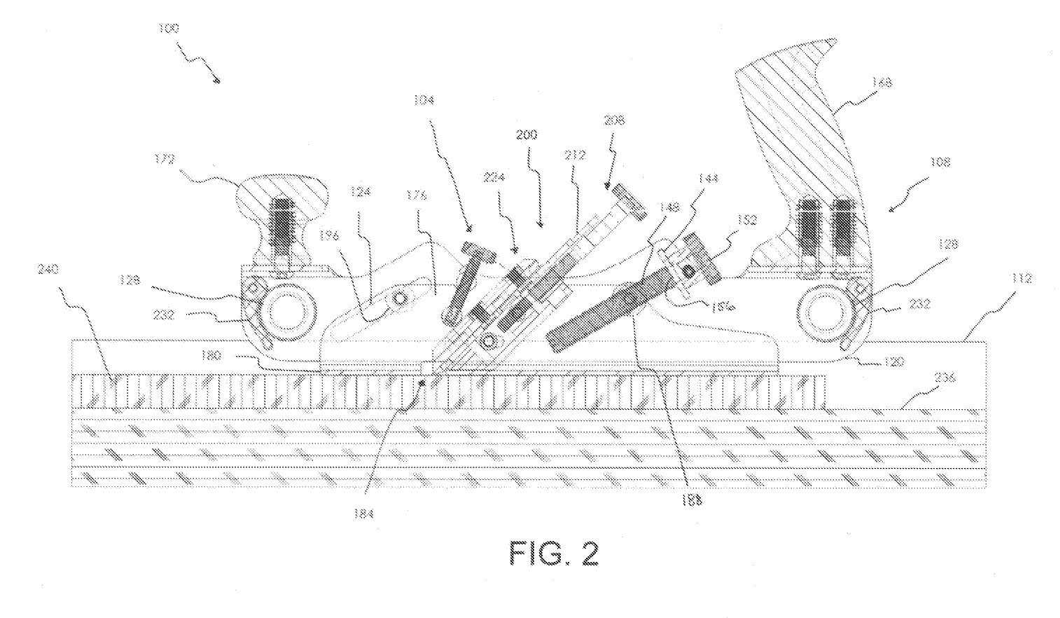

In this embodiment, suspension assembly 104 also includes a cross plate 144, a depth rod 148, and a depth adjustment knob 152. At a high level, these components are designed to engage with and move suspension assembly 104 relative to plane assembly 108. Cross plate 144 includes an aperture 156 (shown in FIG. 2) that is sized and configured to accept depth rod 148.

In an exemplary embodiment, depth rod 148 is a threaded metal rod with a shoulder machined onto one end. Depth rod 148 is inserted through aperture 156 up to the shoulder portion of the depth rod. Depth adjustment knob 152 is engaged with depth rod 148 by means of a set-screw, thereby preventing axial motion of the depth rod. In this way, depth rod 148 and adjustment knob 152 are locked together and fixed axially through aperture 156 in cross plate 144 while remaining free to rotate for adjustment purposes (described in more detail below).

Suspension assembly 104 also includes one or more handles or knobs to allow the user to grip and move the device comfortably and with balance. In an exemplary embodiment, suspension assembly 104 includes a rear tote 168 and front knob 172, which can be made of wood, secured to the suspension assembly frame 120 by means of fasteners inserted through handle attachment holes 132. Other materials suitable for handle construction can also be used, such as, but not limited to, plastics and metals.

Plane assembly 108 is configured to mate with suspension assembly 104 and to include the components necessary to shave portions of wood from a piece of stock. In an exemplary embodiment, plane assembly 108 includes a plane assembly frame 176. In an exemplary embodiment, plane assembly frame 176 is made sheet steel formed in a U-shaped bend pattern, with the bottom of the “U” including a bed 180 of the plane. So as to facilitate the use of a cutting mechanism, there is a cutter opening 184 in bed 180. Plane assembly frame 176 is also pieced by holes for the attachment of additional parts related to the operation of plane assembly 108. Plane assembly frame 176 also includes blade clamp slots 164 which are open ended and angled slots (best seen in FIG. 4), the use of which is described in more detail below.

Plane assembly 108 includes a depth nut 188, which facilitates the movement of plane assembly 108 relative to suspension assembly 104. In an exemplary embodiment, depth nut 188 is a machined steel part that is slid inside plane assembly frame 176 and connected thereto via fasteners. Depth nut 188 has a cross hole 192 (best scene in FIG. 4) which has internal threads (corresponding to the threads of depth rod 148).

Plane assembly 108 also includes a plurality of depth slide pins 196, which are generally installed on opposing sides of plane assembly frame 176 by means of threaded holes or nuts. Depth slide pins 196 cooperate with depth slots 124 in suspension assembly 104 so as to facilitate movement between plane assembly 108 and suspension assembly 104. Depth slide pins 196 may be threaded fasteners with circular heads, where the heads protrude from the sides of plane assembly 108. In use, depth slide pins 196 slide inside depth slots 124, and this connection fixes the two assemblies (e.g., plane assembly 108 and suspension assembly 104) in parallel. In an embodiment, a threaded depth rod 148 is axially secured at one end to depth rod bracket 144 of suspension assembly 104, while the other end of depth rod 148 is threaded into depth nut 192, and the depth nut is fixed rotationally and axially to the plane assembly frame 176 via depth nut bracket 188. A depth adjustment knob 152 is fixed rotationally and axially to the end of depth rod 148. Depth rod 148 axis is in parallel with depth slots 124. Therefore, rotation of the depth adjustment knob 152 will cause depth rod 148 to rotate, which will adjust the position of plane assembly 108 relative to suspension assembly 104.

Cutting mechanism 200 (the details of which are best seen in FIG. 4) includes a frog 204, an adjustment subassembly 208, and blade 212. Frog 204 forms the platform on which blade 212 and adjustment subassembly 208 are secured. In an exemplary embodiment, frog 204 is made of machined metal and is fixed inside the plane assembly frame 176 with fasteners into threaded holes in the frame, through slots on the frog, thereby allowing the frog to be fixed with a limited range of motion forward and back relative to cutter opening 184.

Adjustment assembly 208 allows for the adjustment of blade 212 to different depths, angles, and approaches. In an exemplary embodiment, adjustment assembly 208 is a Norris adjuster that comprises a subassembly of machined parts including a machined threaded rod with two different thread pitches, each thread pitch engaged with an individual nut, the rear nut having a stud that inserts into a hole in frog 204 and the front nut having a stud engaging with holes in blade 212. The threaded rod also can also include a hand knob on the opposite end. The principle of operation and components of the Norris adjuster will be familiar to anyone versed in the design of hand planes.

Placed on the flat upper surface of the frog 204 is the blade 212. The blade 212 is typically made from a flat piece of tool steel, and has a row of evenly spaced circular holes partway along its midline. These holes in blade 212 engage with a stud of the front nut of the adjustment assembly 208 and also engage with movable cap studs 216 that are fixed to a cap iron 220 by means of threaded connections. Movable cap studs 216 are bolted in place in a slot in the cap iron 220, so that by moving their position, the front edge of the cap iron may be adjusted in relation to the edge of blade 212. In an exemplary embodiment, cap iron 220 is made from machined steel.

Installed inside the plane assembly frame 176 is a blade clamp 224 which is part of a subassembly including multiple machined cylinders 160 with shoulders sized to fit into blade clamp slots 164 in the plane assembly frame. Blade clamp 224 also includes a thumb screw (not shown) which is threaded through upper cylinder 160A and fixed into lower cylinder 160B axially but left free to rotate. In use, the thumb screw is turned by the user, which can change the distance between cylinders 160. This change of distance, while in the blade clamp slots 164, forces lower cylinder 160B against cap iron 220 thus holding the cap iron and blade 212 against the top surface of the frog 204.

Blade 212 can be designed so as to be adjusted in a similar fashion to common planes. For example, blade clamp 224 can be adjusted so that when closed down, it will apply an appropriate level of force on cap iron 220 and blade 212 so as to prevent them from shifting under use, but while also allowing the blade's position to be shifted in relation to bed 180 by use of adjustment assembly 208. For blade 212 sharpening, blade clamp 224 is loosened, cap iron 220 and the blade removed, and the cap iron removed from the blade. Movable cap studs 216 that are locked to cap iron 220 allow the cap iron to be returned to the blade 212 in the same position relative to the blade's edge during reassembly after sharpening. When blade wear significantly moves the position of the edge of blade 212, movable cap studs 216 can be loosened and refixed slightly along the slot in cap iron 220, thus readjusting the relationship between the cap iron and the blade.

The effective cutter opening 184 can be altered by loosening the fasteners that fix the blade bed 180 to the plane assembly frame 176, and sliding the blade bed forward or backward before retightening the fasteners. By shifting the blade bed forward, the distance between the blade edge and the front of the cutter opening 184 will be reduced, and by shifting the bed backwards, increased.

Horizontal extensions 116 are inserted or connected to suspension assembly 104 and facilitate the movement of hand tool 100 along guide tracks 112. In an exemplary embodiment, horizontal extensions 116 are constructed of round, hollow metal tube(s). In use, horizontal extensions 116 are inserted through the extension holes 128. In an exemplary embodiment, screws secure horizontal extensions 116 in extension holes 128 via extension lock 232, which are free to rotate around extension lock holes 128. Horizontal extension locks 232 can be latch like levers with a cam profile around the axis of their respective extension hole 128. When extension locks 232 are closed, the extension locks exert a force against the horizontal extensions 116, securing the horizontal extensions against axial movement through the extension holes 128.

In a preferred embodiment, horizontal extensions 116 are removable from suspension assembly 104. In this embodiment, extension locks 232 are moved upward, which relieves pressure on the horizontal extensions 116 can be slid out of the suspension assembly frame 120. In this way the user may select horizontal extensions 116 as wide as required for the work at hand, and will also allow for disassembly of hand tool 100 for compact storage and transport.

Guide tracks 112 are typically two individual pieces, not connected to the other two main subassemblies (e.g., suspension assembly 104 or plane assembly 108) or to one another. Guide tracks 112 are typically placed on a work surface 236 on either side of a workpiece 240. Guide tracks 112 may be constructed of wood and are typically accurately milled rectangular prisms of equal dimension, which allows for consistent depth planing of workpiece 240.

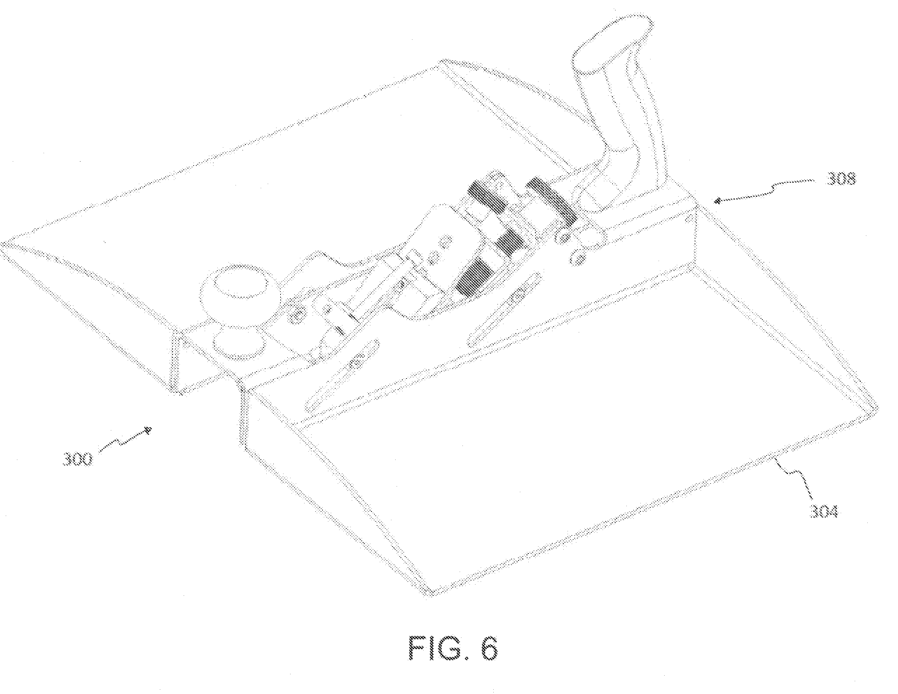

FIG. 6 illustrates another exemplary embodiment of a hand tool, hand tool 300, where the horizontal extended surfaces 304 are integral to a suspension assembly frame 308, rather than being removable tubes.

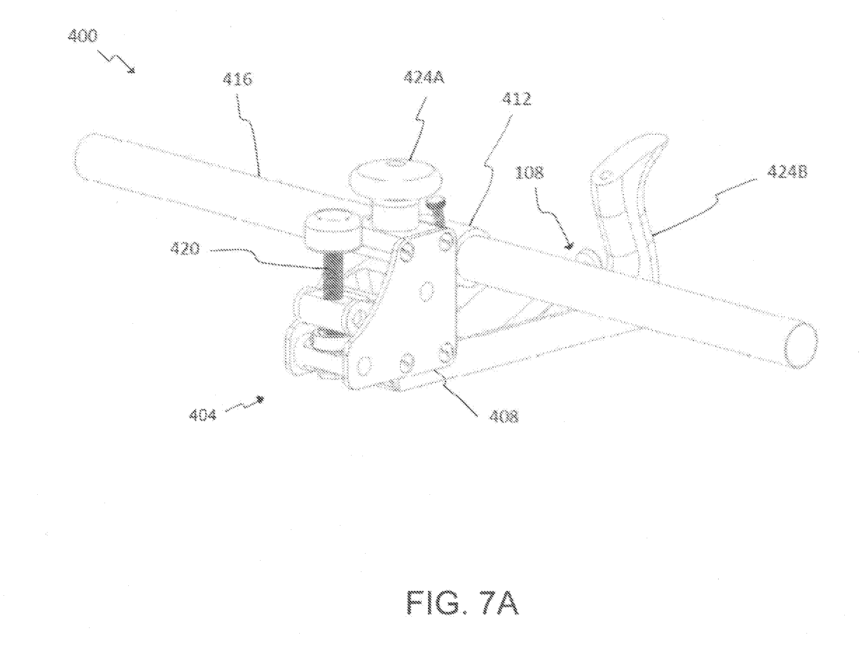

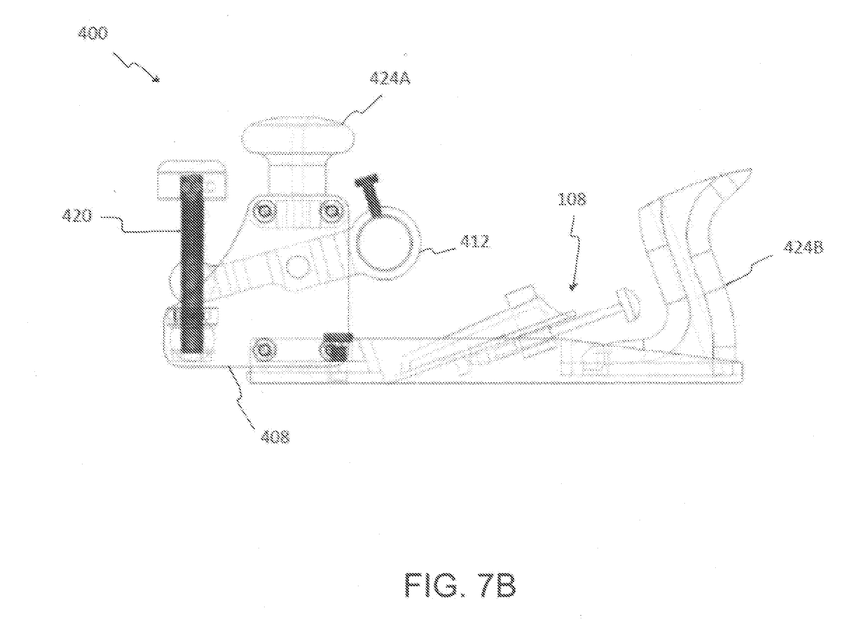

FIGS. 7A and 7B illustrate another exemplary embodiment of a hand tool, hand tool 400, where a suspension frame 404 includes a pivot mechanism 408 connected to plane assembly 108 and has a receiver 412 for a removable horizontal extension 416. In this embodiment, pivot mechanism 408 is locked by a threaded adjustment rod 420 that interfaces with one end of the pivot mechanism. In this case, handles 424A and 424B are mounted to the plane assembly.

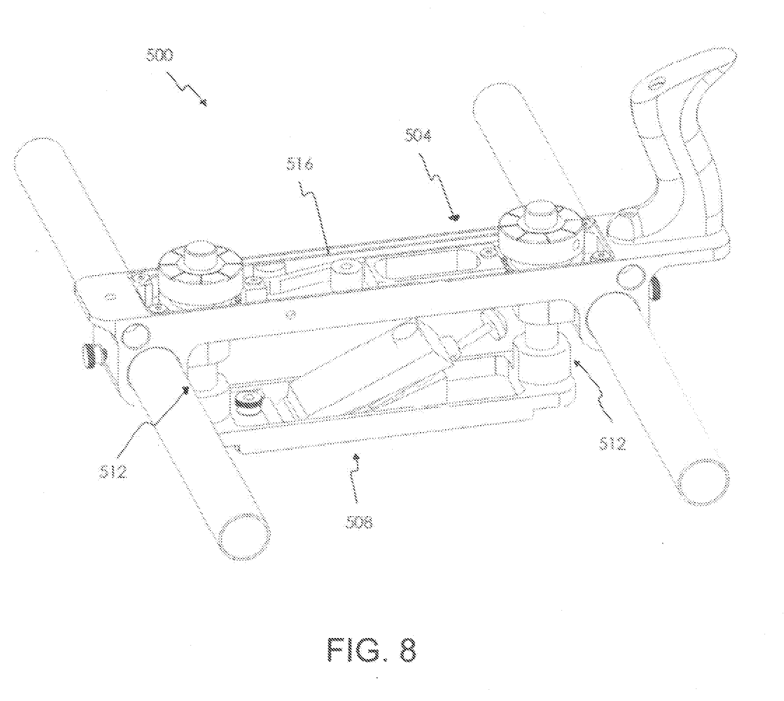

FIG. 8 illustrates yet another embodiment of a hand tool, hand tool 500, where connection and adjustment between a suspension assembly 504 and a plane assembly 508 is provided by two threaded rods 512 between the assemblies, where the threaded rods are linked in their rotation by a chain 516 contained within the suspension assembly 504. Each of threaded rods 512 each have an identical roller chain sprocket (not shown) fixed to them. Chain 516 is connected between the sprockets. Therefore, if one of threaded rods 512 is turned, the other threaded rod turns the same exact amount, as their rotations are kept together by chain 516. The ends of threaded rods 512 are threaded into plane assembly 508. Since threaded rods 512 rotate the same amount as discussed above, plane assembly 508 can be positioned the same distance from suspension assembly 504 along the length of the plane assembly as the threaded rods are rotated, thereby keeping the assemblies in parallel.

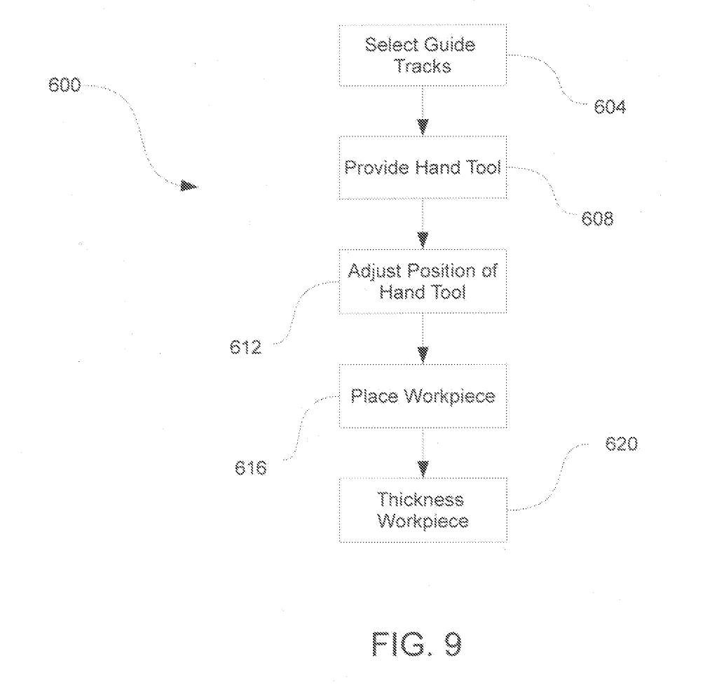

Turning now to FIG. 9, there is shown a block diagram of an exemplary process 600 for thicknessing a workpiece 240 using a hand tool, such as hand tool 100, to a known and reliable thickness.

At step 604, guide tracks 112 are selected. In generally, guide tracks 112 should be chosen so as to have a height that is higher than the final desired thickness to be produced.

At step 608, a hand plane, such as hand tool 100, is provided and placed on the guide tracks 112 such that the bottom of the horizontal extensions 116 are resting on the guide tracks 112.

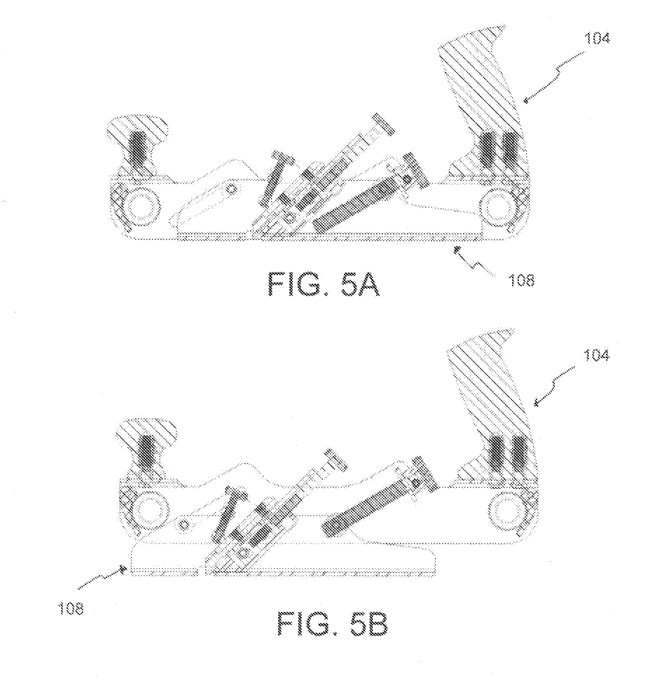

At step 612, the position of the hand plane is adjusted relative to the work surface. In an exemplary embodiment, a depth adjustment knob is turned by the user, which causes plane assembly to slide in the depth slots of the suspension assembly, and in this way the position of the plane bed is moved closer to or further from the work surface as desired by the user. In a preferred embodiment, the user will adjust the depth adjustment knob so as to create a gap between the plane bed and work surface that is equal to or just slightly greater than the final desired workpiece thickness. An exemplary range of displacement between suspension assembly 104 and plane assembly 108 is shown in FIGS. 5A and 5B. It should be noted that because of this continuous adjustable range of adjustment allowed by the combination of suspension assembly 104 and plane assembly 108, guide tracks 112 need only be available in different height increments generally equal to the adjustment range in order to create workpieces of many thicknesses. For example, if the adjustment range between suspension assembly 104 and plane assembly 108 is slightly over one inch, the user need only have on hand guide tracks of heights in one inch increments, so as to create workpieces of all intermediate thicknesses.

At step 616, a workpiece is placed on the work surface in between the guide tracks.

At step 620, the workpiece is planed such that the bed of the plane is pushed over the workpiece so that the blade cuts away material on each pass. Since the workpiece begins process 600 at a greater thickness than the user's final desired thickness, when the plane is cutting away material from the workpiece, the bed of the plane, which is in contact with the workpiece during each cutting pass, keeps the plane above the guide tracks until the final thickness. The user's final desired thickness is achieved once the horizontal extensions are in constant contact with the guide tracks. In this way, process 600 allows the user to avoid monitoring the cutting operation as cutting ceases due to the horizontal extensions encountering the guide tracks. In a preferred embodiment, the workpiece will be formed with a flat surface that is parallel to the work surface because the guide tracks are of equal height and are parallel.

### ADVANTAGES

From the description above, a number of advantages of embodiments of a hand tool as described herein, include, but are not limited to:
The tool can be used to plane a workpiece to a consistent thickness without the need to measure and check during the process of cutting. Moreover, by leaving the initial adjustments to the tool the same, multiple different workpieces can be planed to identical thickness easily.
The advantage described in (a) can be applied to workpieces that are wider than the body of the plane.
Because the extended surfaces on the left and right of the hand tool are connected together and their contact surfaces are in line, adjustment of the cutting depth can be done without potential for disrupting the final parallelism between the plane bed and the work surface.
Adjustment of the cutting depth can be done with a single mechanism, allowing the user to easily fine-tune the final workpiece thickness.
The guide tracks may be produced by the end user out of commonly available materials like wood. In addition, the continuous adjustment provided between the plane bed and the horizontal extensions means that the guide tracks need only be kept at discrete increments of height for the user to produce workpieces of any intermediate thickness. By being simple to produce, the guide tracks may be constructed by the user to suit their specific needs, such as typical workpiece thicknesses, and workpiece lengths.
The tool can be produced with suitable durability and weight for a hand tool.

With a hand tool according to embodiments of the present disclosure, a hand tool woodworker can achieve some of the advantages previously only available to those using powered planers: the ability to thickness wider workpieces in an easy, repeatable way. Using a hand tool as disclosed herein, a user is not required to perform the laborious and skilled measurement procedures traditionally required when thicknessing stock with hand tools, which therefore alleviates one of the most difficult and tedious tasks for the hand tool focused woodworker, while maintaining the advantages of using a hand tool.

While great detail and specificity has been provided for the embodiments described herein, and certain qualities are shared between all embodiments shown, this should not be construed as limiting the scope of the embodiments, but as merely providing illustrations of several embodiments. A partial list of those qualities or features shown in some or all provided embodiments, but not necessarily required in any embodiment, include:
Most or all of the parts described may be manufactured of different materials or by using different manufacturing process from those described.
The internal pieces of the subassemblies may be attached to one another in different ways, or may be absent, or may be combined into unified structures.
The interconnection and adjustment means between the plane assembly and the suspension assembly may be accomplished by other means not described in any of the exampled embodiments.
The plane assembly may have many arrangements for blade fixture and adjustment beyond those exemplified, as there are many common and known blade adjustment designs used for hand planes.
The suspension assembly is designed and configured such that the horizontal extensions to the left and right of the plane assembly are connected together so that when adjusted they stay at equal heights on both sides. However, the horizontal extensions that are coupled to the suspension assembly do not necessarily need to be provided as a single rigid body as shown in the embodiments herein; the extensions may be separate bodies if they are linked together so that their movement is the same on both sides.

Exemplary embodiments have been disclosed above and illustrated in the accompanying drawings. It will be understood by those skilled in the art that various changes, omissions, and additions may be made to that which is specifically disclosed herein without departing from the spirit and scope of the present invention.

What is claimed is:

1. A hand tool for creating a parallel surface opposite the flat side of a workpiece, the hand tool comprising:
a plane assembly including a frame and a blade, wherein the frame has a bed and the blade extends below the bed;
a suspension assembly coupled to the plane assembly, wherein the suspension assembly is adjustable relative to the bed of the plane assembly; and
at least one horizontal extension coupled to the suspension assembly such that the horizontal extension is disposed above the bed of the plane assembly, and wherein the horizontal extension extends substantially orthogonal from the longitudinal axis of the suspension assembly and has a length greater than the width of the workpiece.

2. A hand tool according to claim 1, wherein the suspension assembly is sized and configured to allow the plane assembly to rest inside the suspension assembly.

3. A hand tool according to claim 1, wherein the suspension assembly includes a two opposing parallel sides and wherein each of the two opposing parallel sides includes a plurality of slots.

4. A hand tool according to claim 3, wherein the plane assembly and suspension assembly are coupled together using fasteners within the plurality of slots.

5. A hand tool according to claim 1, wherein the suspension assembly includes a depth assembly, the depth assembly controlling a distance between a lower edge of the suspension assembly and the bed of the plane assembly, such that as the distance between the lower edge of the suspension assembly and the bed of the plane assembly increases a second distance between the horizontal extension and the bed of the plane assembly also increases.

6. A hand tool according to claim 1, further including a pair of substantially similar guide tracks having a thickness greater than a thickness of the workpiece.

7. A hand tool according to claim 1, wherein the horizontal extension is cylindrical, a rectangular prism, or a hexagonal prism.

8. A hand tool according to claim 1, further including a front handle and a rear handle.

9. A hand tool according to claim 8, wherein the front handle and rear handle are coupled to the suspension assembly.

10. A hand tool according to claim 8, wherein the front handle is coupled to the suspension assembly and the rear handle is coupled to the plane assembly.

11. A hand tool according to claim 1, wherein the horizontal extension is a multi-piece member.

12. A hand tool according to claim 1, wherein the suspension assembly includes a plurality of extension holes for use with a suitable number of horizontal extensions.

13. A hand tool kit for creating a parallel surface opposite the flat side of a workpiece, the hand tool kit comprising:
a plane assembly including a frame and a blade, wherein the frame has a bed and the blade extends below the bed;
a suspension assembly coupled to the plane assembly, wherein the suspension assembly is adjustable relative to the bed of the plane assembly;
at least one horizontal extension coupled to the suspension assembly such that the horizontal extension is disposed above the bed of the plane assembly, and wherein the horizontal extension extends substantially orthogonal from the longitudinal axis of the suspension assembly and has a length greater than the width of the workpiece; and
a plurality of guide tracks having substantially similar widths.

14. A hand tool according to claim 13, wherein the suspension assembly is sized and configured to allow the plane assembly to rest inside the suspension assembly.

15. A hand tool according to claim 13, wherein the suspension assembly includes a pivot mechanism coupled to the plane assembly, the pivot mechanism allowing for the insertion and removal of the plane assembly within a portion of the suspension assembly.

16. A hand tool according to claim 13, wherein the suspension assembly includes a depth assembly, the depth assembly controlling a distance between a lower edge of the suspension assembly and the bed of the plane assembly, such that as the distance between the lower edge of the suspension assembly and the bed of the plane assembly increases a second distance between the horizontal extension and the bed of the plane assembly also increases.

17. A hand tool according to claim 13, wherein the horizontal extension is cylindrical, a rectangular prism, or a hexagonal prism.

18. A hand tool according to claim 13, further including a front handle and a rear handle.

19. A hand tool according to claim 1, wherein the horizontal extension is a multi-piece member.

20. A hand tool according to claim 1, wherein the suspension assembly includes a plurality of extension holes for use with a suitable number of horizontal extensions.
